(19) United States
(12) Patent Application Publication
(10) Pub. No.: US 2024/0102284 A1
(43) Pub. Date: Mar. 28, 2024

(54) A Building Panel Assembly

(71) Applicant: Karlta Trading Inc.

(72) Inventor: Georg HASENBERGER, Colborne (CA)

(21) Appl. No.: 17/926,234

(22) PCT Filed: Sep. 29, 2022
(86) PCT No.: PCT/CA2022/051453

§ 371 Date: Nov. 18, 2022

(30) Foreign Application Priority Data
Sep. 28, 2022 (CA) 3176921

(51) Int. Cl. E04C 2/296; B32B 3/14; B32B 5/18; B32B 7/022; B32B 7/04; B32B 21/04; B32B 37/18; E04C 2/38; E04C 2/52

(52) U.S. Cl. CPC E04C 2/296; B32B 3/14; B32B 5/18; B32B 7/022; B32B 7/04; B32B 21/047; B32B 37/18; E04C 2/38; E04C 2/521; E04C 2002/007

(57) ABSTRACT

A building panel assembly is disclosed. The building panel assembly consists of a first layer having one or more laminated softwood or hardwood lumber coupled to each other using finger-joints. Further, a second layer is attached to the first layer, and acts as a thermal insulation for the building panel. Further, an optional third layer is attached to the second layer, and acts as a fire retarding layer for the building panel. Further, one or more framing members are coupled to the second layer and optionally to the third layer, and transversely spaced from each other. The one or more framing members have transversely oriented passageways for passage of wires and pipes.

### FIELD OF THE DISCLOSURE

The present disclosure generally relates to prefabricated building panels, and more particularly relates to a building panel assembly for constructing a building.

### BACKGROUND OF THE DISCLOSURE

The subject matter discussed in this background section should not be assumed to be prior art merely as a result of its mention herein. Similarly, any problems mentioned in this background section or associated with the subject matter of this background section should not be assumed to have been previously recognized in the prior art. The subject matter as disclosed in this background section merely represents different approaches related to assemblies for prefabricated building panels, wherein such assemblies themselves may also correspond to implementations of the subject of this disclosure.

Prefabricated structural panels offer an alternative way to conventional construction techniques of developing and fabricating buildings, due to increasing cost of construction materials, labours, raw materials, time efficiency, weather flexibility, superior quality control. Prefabricated structural panels are used for constructing residential or commercial buildings. Prefabricated structural panels reduce the cost as well as time required for constructing a building. However, the current state of the art is limited to prefabricated structural panels which require further internal or external support that causes thermal bridging (i.e. less thermal efficient). Thermal bridging is understood as occurring when a poorly insulating material provides an easy pathway for heat flow across a thermal barrier. Further, the internal or the external support leads to the risk of weakening the structural integrity of the panel.

Various trades people, such as but not limited to electricians and plumbers, have concerns with existing panels when servicing the existing panels as there is a risk of weakening the structural integrity of the panel or incurring substantial higher costs compared to servicing conventional construction methods.

Currently, there are available alternatives which either revolve around necessitating further structural members by adding cost and complexity or adding further layers after a core structure is fully erected. It should be noted that adding further layers to the core structure is a time-consuming task and tends to require as many skilled workers as conventional construction. Further, some prefabricated structural panels are not water resistant and do not possess any kind of lamination. Therefore, absence of lamination may result in water damage to the panels, reducing the life of the panels and simultaneously reducing the structural integrity of the building.

Therefore, there is a need for an improved prefabricated structural panel that can easily be adapted to various residential, commercial, and industrial building codes and personal preferences in terms of strength, insulation factor, and visual finish as well as ease of servicing of the panel.

There is also a need for an improved prefabricated structural panel wherein delamination of any layer of the panel does not compromise the structural strength and/or integrity of the panel.

### SUMMARY OF THE DISCLOSURE

In accordance with an alternative, the present disclosure relates to a building panel assembly. The building panel assembly may be used for an outer (exterior) wall, an inner (interior) wall, a floor, a ceiling or a roof and the like.

According to one aspect, there is provided a building panel having a top end, a bottom end, a first side and a second side, comprising:
a first load bearing layer having an inner surface and an outer surface;
a second layer having an inner surface and an outer surface, said outer surface of said second layer attached to the inner surface of said first load bearing layer, wherein the second layer is a thermal insulating layer of said building panel assembly; in one alternative, said second layer further provides additional structural integrity to said building panel assembly;
optionally, a third layer having an inner surface and an outer surface, said outer surface of said third layer attached to the inner surface of said second layer, wherein the third layer is a fire retarding layer of said building panel assembly; and
a plurality of spaced apart framing members attached to the inner surface of said second layer, in one alternative, a plurality of spaced apart framing members attached to the inner surface of said third layer, each of said plurality of spaced apart framing members having a first end and a second end, said plurality of spaced apart framing members are oriented such that the first end is adjacent the top end of the building panel assembly and the second end is adjacent the bottom end of the building panel assembly, wherein at least one of the plurality of spaced apart framing members further comprise at least one transversely oriented passageway for receiving at least one of an electrical conduit, plumbing conduit, HVAC and combinations thereof.

In one alternative, the first load bearing layer comprises strips of lumber joined together end to end.

In one alternative, the strips of lumber joined together end to end are face laminated forming a panel.

In one alternative, the strips of lumber joined together end to end are finger jointed.

In one alternative said strips of lumber have a moisture content of from about 0 to about 20%, in one alternative, from 5 to about 12%, preferably from 6 to about 8%.

In one alternative, said second layer comprises an insulating material with a selected thermal resistive value (R-value), said insulating material being selected from the group consisting of: rigid foam, semi-rigid foam and the like.

In one alternative, the third layer comprises a fire-retardant material.

In one alternative, said fire-retardant material is selected from the group consisting of oriented strand board (OSB), cement board, drywall or gypsum board, medium density fibreboard (MDF), plywood and combinations thereof.

In one alternative, each of said plurality of spaced apart framing members comprise at least one transversely oriented passageway for receiving at least one of an electrical conduit, plumbing conduit, HVAC and combinations thereof.

In another alternative, each of said plurality of spaced apart framing members comprise a plurality of spaced-apart transversely oriented passageways for receiving at least one of an electrical conduit, plumbing conduit, HVAC and combinations thereof.

In one alternative, the second layer is attached to the first load bearing layer, the third layer is attached to the second layer and the plurality of spaced-apart framing members are attached to the third layer with glue, nails, screws, staples, bolts and combinations thereof.

In one alternative, the plurality of spaced-apart framing members are attached to the second layer.

In one alternative, the second layer has a thickness in a range to optimize insulation. In one alternative from about 0.5 inches to 24 inches, in another alternative from 4 inches to 8 inches.

In one alternative, the third layer has a thickness in a range from ¼ inch to 2 inches, in one alternative, the third layer has a thickness in a range from ⅜ inches and/or 7/16 inches to ½ inch.

In one alternative, each of the plurality of framing members have a width:height ratio between 1:3 and 2:12 and width:depth ratio selected from the group consisting of 2 inches:2 inches or 2 inches:3 inches.

In one alternative, the building panel further comprises an additional layer attached to the inner surface of the second layer and outer surface of the third layer.

In one alternative, said additional layer is a load bearing layer.

In one alternative, the building panel further comprises a fire break layer.

In another alternative the outer surface of the first layer simulates construction patterns, selected from a group consisting of solid square log construction patterns, brick construction patterns and combinations thereof.

In one alternative, a solid wood layer is integrated within the second layer to provide a greater load bearing capacity to the building panel.

According to another aspect, there is provided a method for fabrication of a first layer of a building panel for constructing a building, the method comprising:
drying lumber of a predefined thickness up to a predefined moisture content percentage;
trimming the dried lumber to remove defects and resize to form one or more long strips of the dried lumber;
joining the one or more long strips of the dried lumber with each other in a finger joint manner; and
face-laminating the joined one or more long strips to form the first layer.

In one alternative, the predefined moisture content percentage of the dried lumber is from about 0 to about 20%, in one alternative, from 5 to about 12%, preferably between 6% to 8%.

In one alternative, the lumber is dried with a uniform moisture content to allow glue to adhere the first layer with a second layer.

In one alternative, the first layer corresponds to a load bearing outer layer of solid wood.

According to another aspect, there is provided a method of assembling a building panel, the method comprising:
processing and altering a laminated softwood or hardwood lumber and combinations thereof to form a first layer;
attaching the processed first layer to a second layer of a predefined thickness;
optionally attaching the second layer to a third layer, wherein the third layer comprises an oriented strand board (OSB), cement board, drywall or gypsum board, medium density fibreboard (MDF) and plywood of a predefined thickness; and
securing one or more spaced-apart framing members on the second layer or optional third layer, wherein at least one of said one or more spaced-apart framing members further comprise a transversely oriented passageway.

In one alternative, the first layer corresponds to a load bearing outer layer of solid wood.

In one alternative, the predefined thickness for the second layer is in a range of from about 0.5 inches to 24 inches, in another alternative from 4 inches to 8 inches.

In one alternative, the predefined thickness of the second layer is adjustable to meet local R-value building code requirements, for example, but not limited to R-13 for walls to R-60 for attic structures, depending on the location of the building as understood by a person of ordinary skill.

According to yet another aspect, there is provided a building wherein at least one of a floor, wall, ceiling and roof of said building comprises the building panel as described herein.

In one alternative, said building is selected from the group consisting of a residential building, commercial building, industrial building, recreational building, farm building or combinations thereof.

In another alternative, the floor, wall, ceiling and roof of said building comprise the building panel as described herein.

In another alternative, said wall is selected from an exterior wall, and interior wall and combinations thereof.

According to another aspect, there is provided a building panel assembly comprising a building panel for constructing a building. The building panel comprises a first layer having one or more laminated softwood or hardwood lumber and combinations thereof coupled to each other using finger-joints. The first layer corresponds to a load bearing outer layer of solid wood. The term “load bearing” as used herein means a portion of the building panel that is able to support the weight that is carried (e.g. overlying parts of a building) by the panel. The first layer is machined to simulate construction patterns, selected from a group of patterns of solid square log construction patterns, and brick construction patterns. Further, a second layer is attached to the first layer and acts as a thermal insulation for the building panel. The second layer may be attached to the first layer in any way that will secure the first layer to the second layer. Some modes of attachment include gluing, adhering, nailing, screwing, stapling and combinations thereof. The second layer corresponds to a layer of rigid foam, semi-rigid foam and the like constructed of a predefined thickness. The predefined thickness of the second layer is in a range of from about 0.5 inches to 24 inches, in another alternative from 4 inches to 8 inches, and in another alternative from about 4 inches to 6 inches. It should be noted that the predefined thickness of the second layer is adjustable to meet local R-value building code requirements, for example, but not limited to R-13 for walls to R-60 for attic structures, depending on the location of the building as understood by a person of ordinary skill. Further, in one alternative, a solid wood layer is integrated within the second layer to provide a greater load bearing capacity to the building panel. Further, an optional third layer is attached to the second layer and acts as a fire retarding layer for the building panel. Some modes of attachment include gluing, adhering, nailing, screwing, stapling and combinations thereof. The optional third layer, in one alternative, is an oriented standard board (OSB) layer of a predefined width to serve as a fire retarding layer. The predefined width of the OSB layer is selected as 7/16 inches or ⅜ inches or ½ inches. Further, one or more studs, are coupled to the second layer or the optional third layer and transversely spaced from each other. In one alternative, each of the one or more studs are constructed in a finger joint form and further comprise at least one transverse channel for the passage of electrical wires, communication wires, fibre optics, plumbing lines, HVAC and combinations thereof. In one alternative, each of the one or more studs have 2 inches×2 inches or 2 inches×3 inches dimension. The studs may be coupled to the second layer or optional third layer by conventional means including but not limited to gluing, nailing, screwing, stapling and combinations thereof. In one alternative, a fire break layer is integrated within at least one of the first layer, the second layer, the optional third layer and the one or more studs, to act as a fire “break” in case of fire. Thus, such coupling of the first layer, the second layer, the optional third layer and the one or more studs with each other, forms, in one alternative, an outer shell building panel assembly.

In accordance with another alternative, there is provided a method for fabrication of a first layer of a building panel for use in constructing a building. The method comprises drying a lumber of a predefined thickness up to a predefined moisture content percentage. The predefined moisture content percentage left within the dried lumber may be from about 0 to about 20%, in one alternative, from 5 to about 12%, and in another alternative between 6% to 8%. Further, the method comprises trimming the dried lumber to remove defects and resize to form one or more long strips of the dried lumber. Further, the method comprises joining the one or more long strips with each other, preferably in a finger joint manner. Thereafter, the method comprises face-laminating the one or more long strips to form panels of the first layer.

In accordance with another alternative, a method of preparing a building panel for use in the manufacture of a building is disclosed. The method comprises processing and altering a laminated softwood or hardwood lumber to form a first layer; gluing the processed first layer with a second layer of a predefined thickness; optionally adhering the second layer with a third layer, wherein the third layer comprises a material selected from an oriented strand board (OSB), cement board, drywall or gypsum board, medium density fibreboard (MDF), plywood and combinations thereof of a predefined thickness; and securing one or more studs onto the second layer or optional third layer, said one or more studs further comprising one or more passages, preferably transverse passages for passage of electrical wires, fiber optics, plumbing conduits and combinations thereof.

### BRIEF DESCRIPTION OF THE DRAWINGS

While the specification concludes with claims particularly pointing out and distinctly claiming particular alternatives of the present disclosure, various alternatives of the present disclosure can be more readily understood and appreciated from the following descriptions alternatives of the present disclosure when read in conjunction with the accompanying drawings, in which:

FIG. 1 illustrates a perspective back view of a building panel, according to an alternative of the present disclosure;

FIG. 2 illustrates a perspective front view of the building panel, according to an alternative of the present disclosure;

FIG. 3 illustrates a flowchart showing a method for fabrication of a first layer of a building panel for constructing a building, according to an alternative of the present disclosure;

FIG. 4 illustrates a flowchart showing a method of fabricating a building panel, according to an alternative of the present disclosure; and

FIG. 5 illustrates a building having multiple building panels as an exterior wall, interior wall, interior floor, and roof/ceiling, according to an alternative of the present disclosure.

### DETAILED DESCRIPTION

Reference will now be made in detail to specific alternatives or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

Some alternatives of this disclosure, illustrating all its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context dictates otherwise. Although any systems and methods similar or equivalent to those described herein can be used in the practice or testing of alternatives of the present disclosure, the preferred systems, and methods are now described.

Alternatives of the present disclosure will be described more fully hereinafter with reference to the accompanying drawings in which like numerals represent like elements throughout the several figures, and in which example alternatives are shown. Alternatives of the present disclosure may, however, be embodied in alternative forms and should not be construed as being limited to the alternatives set forth herein. The examples set forth herein are non-limiting examples and are merely examples among other possible examples.

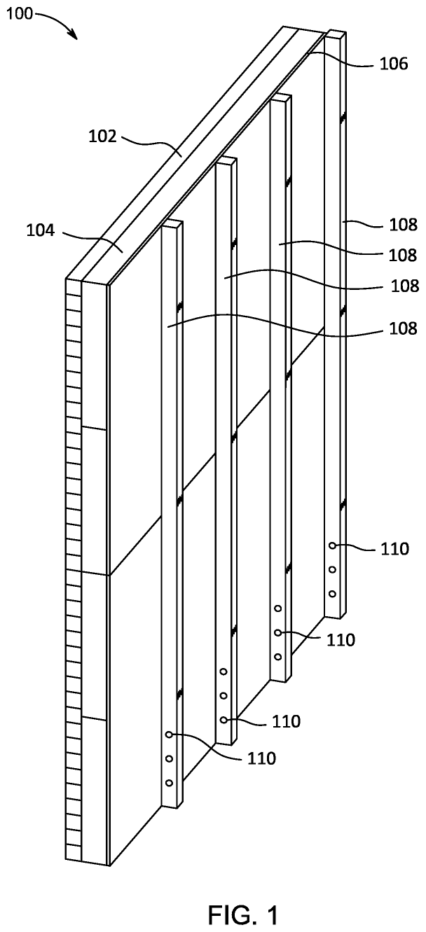

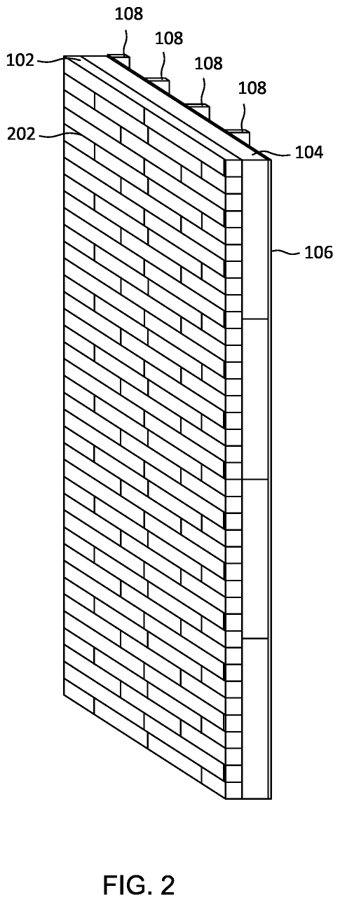

FIG. 1 illustrates a perspective back view of a building panel 100, according to an alternative of the present disclosure. FIG. 1 is described in conjunction with FIG. 2. The building panel 100 may be a prefabricated structural panel arranged with multiple building panels to construct a building. The multiple building panels arranged together, may be described, in one alternative as an outer shell building panel assembly. The building panel 100 may comprise a first layer 102, a second layer 104, a third layer 106, and one or more studs 108.

The first layer 102 may correspond to a load bearing outer layer. The first layer 102 having one or more laminated softwood pieces of lumber (or in the alternative laminated hardwood) coupled to each other using finger-joints as understood by a person of ordinary skill in the art. The first layer 102 may act as a structural element of a building responsible to hold weight of elements mounted over the top end of the first layer 102. The one or more laminated softwood pieces of lumber may be low-grade softwood lumber which is an industrial graded wood. The low-grade softwood lumber may have more wane and knots in comparison to a higher wood material. It should be noted that the low-grade softwood lumber is lighter and is of a lower density than the higher wood material making it more economical to use.

Further, the low-grade softwood lumber may be processed such that, the moisture content of the low-grade softwood lumber is from about 0 to about 20%, in one alternative, from 5 to about 12%, and in another alternative from about 6% to 8%. Further, the low moisture content is uniformly distributed throughout the low-grade softwood lumber to allow for glue to work properly. Thus, the low moisture content within the low-grade softwood lumber increases the adhesive property of the glue applied over the first layer 102 to adhere to the second layer 104. Further, the low moisture content restricts formation of bacteria and other moisture related fungus over the surface of the first layer 102. This enhances the life, durability, and internal strength of the first layer 102, that overall increases the internal integrity of the building panel 100. Further, the first layer 102 may simulate construction patterns 202, as shown in FIG. 2, that are selected from, but not limited to, solid square log construction patterns or brick construction patterns. The construction patterns 202 may provide different designs to the building panel 100 without compromising on structural rigidity of the building panel 100.

In an alternative, the first layer 102 may be face laminated. The face-laminated first layer 102 may be more stable than a conventional construction lumber. It should be noted that the conventional construction lumber due to its higher moisture content, over time may shrink and warp thereby causing various problems such as popping drywall screws, causing doors or windows to jam, develop cracks in walls and ceilings.

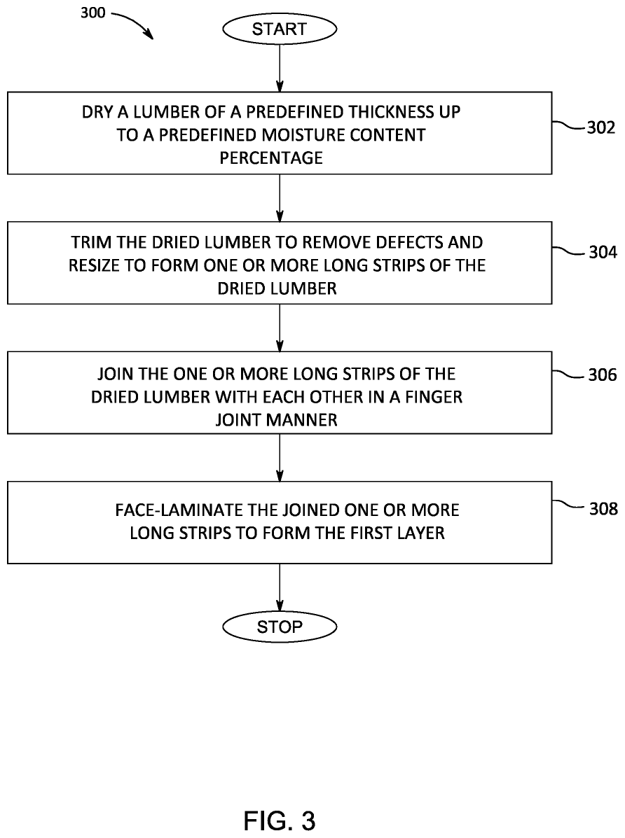

In one exemplary alternative, the first layer 102 may be constructed from lumber of 2 inches by 4 inches or 2 inches by 3 inches in width:depth ratio dimension. The first layer 102 may be finger jointed to provide an interlocking mechanism of the lumber. The interlocking mechanism may enhance the strength of the first layer 102. In one alternative, a user may re-saw the solid wood panels of the first layer 102 to produce a desired panel size for custom walls such as but not limited to interior walls. The detailed description for fabricating the first layer 102 of the building panel 100, is described in conjunction with FIG. 3.

Further, the second layer 104 may be glued to the first layer 102. In one alternative, the second layer 104 may be face glued to one side of the first layer 102. The second layer 104 may act as a mid-layer for the building panel 100. Further, the second layer 104 may be fabricated with a layer of a rigid foam of a predefined thickness to maintain a thermal insulation for the building panel 100. The rigid foam may generally be constructed of high-quality, green-friendly materials. In one alternative, the rigid foam of the second layer 104 may be made from a material selected from a group of materials of polyisocyanurate, extruded polystyrene, expanded polystyrene and combinations thereof. It should be noted that the rigid foam performs well when subjected to moisture and does not change dimensions, split, or crack.

In one alternative, the rigid foam of the second layer 104 of the building panel 100 may significantly reduce the energy user of the building. The rigid foam may be useful in controlling indoor temperatures. Further, the rigid foam may eliminate gaps, holes, and air leaks of the building panel 100 and thereby reduce energy bills and conserve valuable resources. In one alternative, the rigid foam may eliminate passage of moisture through the building panel 100. It should be noted that the moisture may increase mould and mildew in a building envelope. Therefore, a properly installed rigid foam for the second layer 104 may provide a layer of protection against moisture damage.

In one alternative, the predefined thickness for the second layer 104 may be in a range of 4 inches to 6 inches. The second layer 104 of rigid foam of predefined thickness may be adjustable to meet local R-value building code requirements, for example, but not limited to R-13 for walls to R-60 for attic structures, depending on the location of the building as understood by a person of ordinary skill. In one alternative, the rigid foam of 4 inches to 6 inches or higher may increase the R-value of the entire building panel 100 with a long-term R-value. In one alternative, the predefined thickness of the second layer 104 may be adjusted to any R-value desired by a user.

It should be noted that the second layer 104 may provide an insulation layer which may only be interrupted by openings such as doors and windows and by additional header requirements of large openings. Further, standard size openings up to a certain width for leaving a minimum header space may not require any additional header and therefore may not form the insulation layer.

Further, the third layer 106 may be glued to the second layer 104. In one alternative, the third layer 106 may be face glued to one side of the second layer 104. The third layer 106 may correspond to an inner layer of the building panel 100. The third layer 106, in one alternative, consists of an oriented standard board (OSB) layer of a predefined width that serves as a fire retarding layer for the building panel 100. The predefined width of OSB layer may be selected from a range of 7/16 inches or ⅜ inches or ½ inches. It should be noted that the OSB layer may be a versatile engineered wood panel made using waterproof heat-cured adhesives or rectangular shaped wood strands arranged in cross-oriented layers. Cement board may also be used as an alternative as described above. In one alternative, the predefined thickness of the third layer 106 may be lower than the predefined thickness of the first layer 102 and the predefined thickness of the second layer 104 of the building panel 100.

Further, the one or more studs 108, may be coupled to the third layer 106 and transversely spaced from each other, as shown in FIG. 1. The one or more studs 108 may correspond to an outer most layer of the inside of the building panel 100. In one alternative, the one or more studs 108 include transverse channels or passages 110 for passage of electrical conduit, plumbing conduit and combinations thereof. Each of the one or more studs 108 may be manufactured by being finger jointed to enhance strength and durability to the one or more studs 108. The finger jointed mechanism of the one or more studs 108 is constructed in a finger joint configuration or end-to-end configuration or comb joint configuration. The finger joint configuration may be made by cutting a set of complementary, interlocking profiles in two pieces of wood which are further glued. The finger joint mechanism corresponds to an interlocking configuration between fingers of two hands interlocked with each other. In one alternative, each of the one or more studs 108 may be constructed in and dimension as understood by a person of ordinary skill in the art, for example, but not limited to 2 inches×2 inches or 2 inches×3 inches dimension, without departing from the scope of the disclosure.

Further, as discussed above, the one or more studs 108 include one or more passages 110 to allow passage of wires that may be provide for electrical transmission or communication transmission, or conduit for services such as, but not limited to, water, for the building. Further, the one or more studs 108 may be used to fasten panels, such as a drywall or others, for the interior finish of the wall panel. Thus, the coupling of the first layer 102, the second layer 104, the third layer 106, and the one or more studs 108, with each other, form the building panel assembly, and in one alternative, the outer shell building panel assembly.

In one alternate alternative, a fire break layer (not shown) may be integrated within at least one of the first layer 102, the second layer 104, the third layer 106, and the one or more studs 108 for fire breakage. In one alternative, the fire break layer may be used in multi-unit housing or commercial applications or industrial applications. In one alternative, the fire break layer may be constructed of a flame-retardant material placed within at least one of the first layer 102, the second layer 104, the third layer 106, and the one or more studs 108, for the fire breakage.

In an alternative, a solid wood layer (not shown) may be integrated between the second layer 104 and the third layer 106 to provide greater load bearing capacity to the building panel 100. In one alternative, the solid wood layer may be sandwiched between the second layer 104 and the third layer 106. The solid wood layer may provide additional structural rigidity to the building panel 100 to withstand greater loads.

FIG. 3 illustrates a flowchart showing a method 300 for fabrication of the first layer 102 for constructing a building, according to an alternative of the present disclosure. FIG. 3 is described in conjunction with FIGS. 1 and 2.

At first, the lumber of the predefined thickness is dried up to the predefined moisture content percentage, at step 302. The first layer 102 corresponds to the load bearing outer layer or solid wood wall made from the low-grade softwood lumber. For example, a wood log of 2 inches by 4 inches is dried till 6% of moisture content is left. It should be noted that the lumber is dried to maintain uniform moisture content to allow glue to adhere the first layer 102 with the second layer 104, the third layer 106 and the one or more studs 108, in an upright orientation.

Successively, the dried lumber is trimmed to remove defects and resized to form one or more long strips of the dried lumber, at step 304. For example, the dried wood log is trimmed to remove wind cracks and knot defects and then cut into strips, for example of 0.6 inches by 1.3 inches. Further, the one or more long strips may be joined with each other in a finger joint manner, at step 306. In one alternative, the one or more long strips are joined to form the interlocking mechanism. For example, 3 strips of 0.5 inches 0.6 inches by 1.3 inches up to 2 inches, are joined in the finger joint manner or in a comb joint manner.

Successively, the one or more long strips are face-laminated to form large panels of the first layer 102, at step 308. In one alternative, the face lamination of the one or more long strips eliminates spillage or absorption of water or other liquids inside the building panel 100. In another alternative, the face lamination also enhances durability of the first layer 102 and therefore, the building panel 100. For example, the finger jointed long strips of lumber are face-laminated, in one alternative using chipboard.

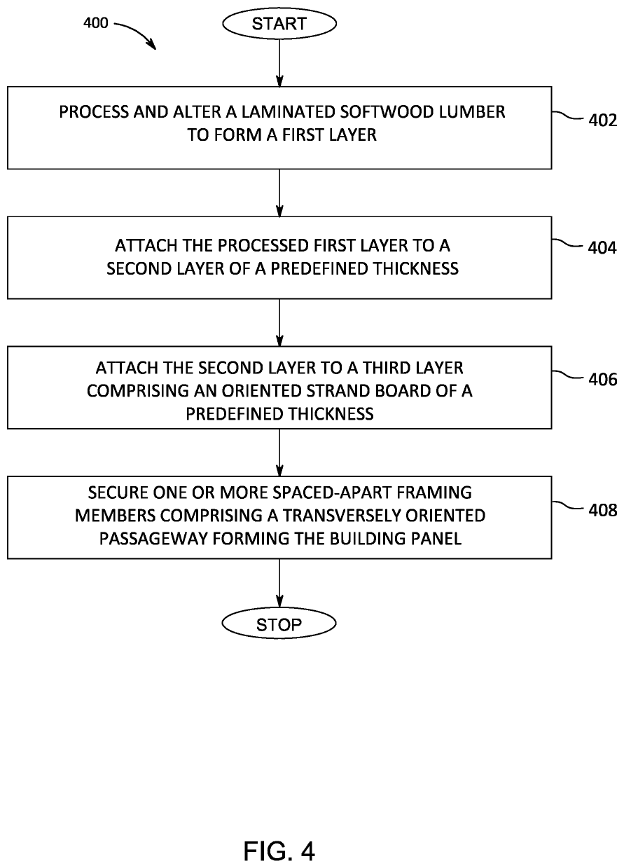

FIG. 4 illustrates a flowchart of a method 400 of securing the building panel 100 of the building, according to an alternative of the present disclosure. FIG. 4 is described in conjunction with FIGS. 1, 2, and 3.

At first, laminated softwood lumber (or hardwood) is processed and altered to form the first layer 102, at step 402. The first layer 102 corresponds to the load bearing outer layer or solid wood wall made from the low-grade softwood lumber. For example, a lumber of 2 by 4 inches is taken, that is processed to form the first layer 102 of 2 by 4 inches, as mentioned in FIG. 3.

Successively, the processed first layer 102 is glued with the second layer 104 of the predefined thickness, at step 404. In one alternative, the second layer 104 may be face glued to one side of the first layer 102. The second layer 104 may act as a mid-layer for the building panel 100. Further, the second layer 104 may be fabricated with a layer of a rigid foam, semi-rigid foam and the like, of a predefined thickness to maintain a thermal insulation for the building panel 100. The predefined thickness for the second layer 104 may be in a range of in one alternative from about 0.5 inches to 24 inches, in another alternative from 4 inches to 8 inches, and in another alternative, from about 4 inches to 6 inches. The second layer 104 of rigid foam, semi-rigid foam and the like of minimum thickness may be adjustable to meet local R-value building code requirements, for example, but not limited to R-13 for walls to R-60 for attic structures, depending on the location of the building as understood by a person of ordinary skill. For example, the 2 by 4 inches of the first layer 102 is glued with 4 inches wide second layer 104.

Successively, the second layer 104 is adhered with the third layer 106, at step 406. The third layer 106 comprises the OSB of the predefined thickness. In one alternative, the third layer 106 may be face glued to one side of the second layer 104. The third layer 106 may correspond to an inner layer of the building panel 100. The third layer 106 consists of an oriented standard board (OSB) layer of a predefined width that serves as a fire retarding layer for the building panel 100. The predefined width of OSB layer may be selected from a range of 7/16 inches or ⅜ inches or ½ inches. It should be noted that the OSB layer may be a versatile engineered wood panel made using waterproof heat-cured adhesives or rectangular shaped wood strands arranged in cross-oriented layers. For example, a ⅜ inches thick OSB is adhered over one side of the second layer 104.

Successively, the one or more studs 108, are secured to the third layer to form the building panel 100, at step 408. The one or more studs 108 may be finger jointed to enhance strength and durability to the one or more studs 108. The finger jointed mechanism of the one or more studs 108 is constructed in a finger joint configuration or end-to-end configuration or comb joint configuration. The finger joint configuration may be made by cutting a set of complementary, interlocking profiles in two pieces of wood which are further glued. The finger joint mechanism corresponds to an interlocking configuration between fingers of two hands interlocked with each other. In one alternative, each of the one or more studs 108 may be constructed in 2 inches×2 inches or 2 inches×3 inches dimension, without departing from the scope of the disclosure. For example, 108 studs of 2 inches by 2 inches are secured in vertical orientation over one side of the third layer 106. Further, each of the 108 studs are predrilled with 3 holes of a preferred diameter to accommodate the passage of the services required. Further, the 108 studs of 2 inches by 2 inches are positioned over the third layer 106 transversely at an equal gap between each other, such as, but not limited to 12-inch or 16-inch centres, as understood by a person of ordinary skill in the art.

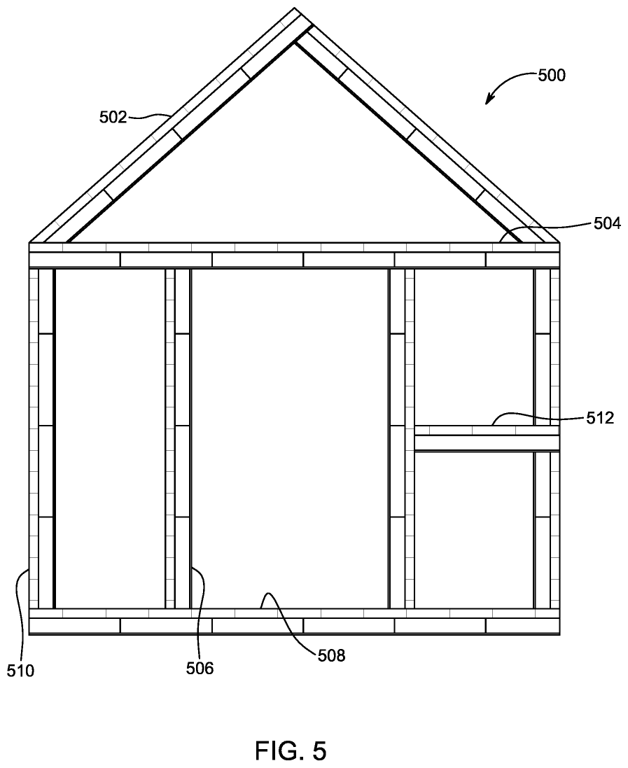

FIG. 5 illustrates a building 500 having multiple building panels as an exterior wall, interior wall, interior floor, and roof/ceiling, according to an alternative of the present disclosure.

The building 500 may comprise a roof 502, a ceiling 504, one or more interior walls 506, a floor 508, one or more exterior walls 510, and an interior floor 512, as shown in FIG. 5. The roof 502, the ceiling 504, the one or more interior walls 506, the floor 508, the one or more exterior walls 510, and the interior floor 512, of the building 500 may be made from the building panel 100 having the first layer 102 as the load bearing outer layer, and other internal layers, as discussed above in FIG. 1. The building 500 may be a residential building or a commercial building. In one alternative, the building 500 may be completely modular made from the prefabricated panels. It may be noted that the construction of the building 500 using the prefabricated panels of FIG. 1, for the roof 502, the ceiling 504, the one or more interior walls 506, the floor 508, the one or more exterior walls 510, and the interior floor 512 may have minimal labour cost and thereby saving overall construction cost and time.

The building panel 100 may be the prefabricated structural panel arranged with multiple building panels to construct the building 500. In one alternative, the roof 502, the ceiling 504, the one or more interior walls 506, the floor 508, the one or more exterior walls 510, and the interior floor 512 of the building 500 may have modular functionality considering flexibility of construction of the building 500. The prefabricated panels for the construction of the building 500 may be assembled and dissembled with reduction of cost.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the alternatives of the apparatus illustrated and described herein are by way of example, and the scope is not limited to the exact details of construction.

While the above description contains many specificities, these should not be construed as limitations on the scope, but rather as an exemplification of one alternative thereof. It should be understood that the broadest scope includes modifications such as diverse shapes, sizes, and materials. Accordingly, the scope should be determined, not by the alternatives illustrated, but by the appended claims and their legal equivalents.

While there is shown and described herein certain specific structures embodying various alternatives, it will be manifest to those skilled in the art that various modifications and rearrangements of the parts may be made without departing from the spirit and scope of the underlying concept and that the same is not limited to the particular forms herein shown and described except insofar as indicated by the scope of the appended claims.

It may be appreciated by one skilled in the art that additional alternatives may be contemplated. These and other advantages will be apparent to those skilled in the art.

### LIST OF ELEMENTS

100 Building Panel
102 First layer
104 Second layer
106 Third layer
108 One or more studs
110 One or more passages
202 Construction Patterns
300 Method
302 Step
304 Step
306 Step
308 Step
400 Method
402 Step
404 Step
406 Step
408 Step
500 Building
502 Roof
504 Ceiling
506 One or more interior walls
508 Floor
510 One or more exterior walls
512 Interior Floor

What is claimed is:

1. A building panel having a top end, a bottom end, a first side and a second side, comprising: a first load bearing layer having an inner surface and an outer surface;
a second layer having an inner surface and an outer surface, said outer surface of said second layer attached to the inner surface of said first load bearing layer, wherein the second layer is a thermal insulating layer of said building panel; and
a plurality of spaced apart framing members attached to the inner surface of said second layer, each of said plurality of spaced apart framing members having a first end and a second end, said plurality of spaced apart framing members are oriented such that the first end is adjacent the top end of the building panel and the second end is adjacent the bottom end of the building panel, wherein at least one of the plurality of spaced apart framing members further comprise at least one transversely oriented passageway.

2. The building panel of claim 1 further comprising a third layer having an inner surface and an outer surface, said outer surface of said third layer attached to the inner surface of said second layer, wherein the third layer is a fire retarding layer of said building panel; wherein each of said plurality of spaced apart framing members are attached to the inner surface of said third layer.

3. The building panel of claim 1, wherein the first load bearing layer comprises strips of lumber selected from the group consisting of softwood, hardwood and combinations thereof joined together end to end.

4. The building panel of claim 13, wherein the first load bearing layer comprises strips of
lumber selected from the group consisting of softwood, hardwood and combinations thereof joined together end to end, wherein the strips of lumber joined together end to end are face laminated forming a panel.

5. The building panel of claim 1, wherein the first load bearing layer comprises strips of lumber selected from the group consisting of softwood, hardwood and combinations thereof joined together end to end, wherein the strips of lumber joined together end to end are finger jointed.

6. The building panel of claim, wherein the first load bearing layer comprises strips of lumber selected from the group consisting of softwood, hardwood and combinations thereof joined together end to end, wherein said strips of lumber have a moisture content selected from about 0 to about 20%, from 5 to about 12%, and from 6 to about 8%.

7. The building panel of claim 1 wherein said second layer comprises an insulating material with a selected R-value, said insulating material being selected from the group consisting of: rigid foam, semi-rigid foam and the like.

8. The building panel of claim 2, wherein the third layer comprises a fire-retardant material.

9. The building panel of claim 2, wherein the third layer comprises a fire-retardant material, wherein said fire-retardant material is selected from the group consisting of oriented strand board (OSB), cement board, drywall or gypsum board, medium density fibreboard (MDF), plywood and combinations thereof.

10. The building panel of claim 1, wherein each of said plurality of spaced
apart framing members comprise at least one transversely oriented passageway.

11. The building panel of claim 1, wherein each of said plurality of spaced
apart framing members comprise a plurality of spaced-apart transversely oriented passageways.

12. The building panel of claim 2, wherein the second layer is attached to
the first load bearing layer, the third layer is attached to the second layer and the plurality of spaced-apart framing members are attached to the third layer with glue, nails, screws, staples, bolts and combinations thereof.

13. The building panel of claim 1, wherein the second layer has a thickness
in a range selected from the group consisting of from about 0.5 inches to 24 inches, from about 4 inches to 8 inches and from about 4 inches to 6 inches.

14. The building panel of claim 2, wherein the third layer has a thickness in
a range from 7/16 inches to ½ inches.

15. The building panel of claim 1, wherein each of the plurality of framing
members have a width to depth ratio selected from the group consisting of 2 inches:2 inches or 2 inches:3 inches.

16. The building panel of claim 2, further comprising an additional layer
attached to the inner surface of the second layer and outer surface of the third layer.

17. The building panel of claim 2, further comprising an additional layer attached to the
inner surface of the second layer and outer surface of the third layer, wherein said additional layer is a load bearing layer.

18. The building panel of claim 1 further comprising a fire break layer.

19. The building panel of claim 1, wherein the outer surface of the first load
bearing layer simulates construction patterns, selected from a group consisting of solid square log construction patterns, brick construction patterns and combinations thereof.

20. The building panel of claim 1, wherein a solid wood layer is integrated
within the second layer to provide a greater load bearing capacity to the building panel.

21. A method for fabrication of a first layer of a building panel for constructing a building, the method comprising:
drying lumber of a predefined thickness up to a predefined moisture content percentage; trimming the dried lumber to remove defects and resize to form one or more long strips of the dried lumber; joining the one or more long strips of the dried lumber with each other in a finger joint manner; and face-laminating the joined one or more long strips to form the first layer.

22. The method of claim 2, wherein the predefined moisture content percentage of the dried lumber is between 6% to 8%.

23. The method of claim 21, wherein the lumber is dried with a uniform moisture content to allow glue to adhere the first layer with a second layer.

24. The method of claim 21, wherein the first layer corresponds to a load bearing outer layer of solid wood.

25. A method for fabricating a building panel of a building, the method comprising:
processing and altering a laminated softwood or hardwood lumber to form a first layer;
attaching the processed first layer to a second layer of a predefined thickness; and
securing one or more spaced-apart framing members on the second layer, wherein at least one of said one or more spaced-apart framing members further comprise a transversely oriented passageway, forming a building panel.

26. The method of claim 25 further comprising attaching the second layer to a third layer, wherein the third layer comprises a material selected from the group consisting of an oriented strand board (OSB), cement board, drywall or gypsum board, medium density fibreboard (MDF), plywood and combinations thereof of a predefined thickness; and securing said one or more spaced-apart framing members on the third layer.

27. The method of claim 25, wherein the first layer corresponds to a load bearing outer layer of solid wood.

28. The method of claim 25, wherein the predefined thickness for the second layer is selected from the group consisting of from about 0.5 inches to 24 inches, from about 4 inches to 8 inches, and from about 4 inches to 6 inches.

29. The method of claim 25, wherein the predefined thickness of the second layer is adjustable to meet local R-value building code requirements.

30. A building wherein at least one of a floor, wall, ceiling and roof of said building comprises the building panel of claim 1.

31. The building of claim 30, wherein said building is selected from the group consisting of a residential building, commercial building, recreational building, farm building and combinations thereof.

32. The building of claim 30, wherein the floor, wall, ceiling and roof of said building comprise the building panel of claim 1.

33. The building of claim 32 wherein said wall is selected from an exterior wall, and interior wall and combinations thereof.
